(19) United States
(12) Patent Application Publication
(10) Pub. No.: US 2009/0301996 A1
(43) Pub. Date: Dec. 10, 2009

(54) FORMULATIONS FOR REMOVING COOPER-CONTAINING POST-ETCH RESIDUE FROM MICROELECTRONIC DEVICES

(75) Inventors: Pamela M. Visintin, North Charleston, SC (US); Michael B. Korzenski, Danbury, CT (US); Thomas H. Baum, New Fairfleid, CT (US)

Correspondence Address: MOORE & VAN ALLEN PLLC, P.O. BOX 13706, Research Triangle Park, NC, 27709, US

(73) Assignee: ADVANCED TECHNOLOGY MATERIALS, INC., Danbury, CT (US)

(21) Appl. No.: 12/093,125

(22) PCT Filed: Nov. 7, 2006
(86) PCT No.: PCT/US06/60582

§ 371 Date: Sep. 5, 2008

Related U.S. Application Data
(60) Provisional application No. 60/734,729, filed on Nov. 8, 2005.

(51) Int. Cl. B44C 1/22; C11D 3/00

(52) U.S. Cl. 216/13; 510/175

(57) ABSTRACT

A method and composition for removing copper-containing post-etch and/or post-ash residue from patterned microelectronic devices is described. The removal composition includes a diluent, a solvent and a copper corrosion inhibitor, wherein the diluent may be a dense fluid or a liquid solvent. The removal compositions effectively remove the copper-containing post-etch residue from the microelectronic device without damaging exposed low-k dielectric and metal interconnect materials.

### FIELD OF THE INVENTION

The present invention relates to compositions useful for the removal of residue, preferably copper-containing post-etch and/or post-ash residue, from the surface of substrates, preferably microelectronic devices, and methods of using said compositions for removal of same.

### DESCRIPTION OF THE RELATED ART

The use of copper interconnects co-extensively with low-k dielectric layers presents a multitude of challenges to microelectronic device manufacturers and suppliers of materials which are used in process integration. During the etching of high aspect ratio structures typical of today's microelectronic devices, copper residue is often back-sputtered onto the structure sidewalls and top surface, where it readily diffuses into the dielectric material and eventually reaches the front-end device. The back-sputtered copper residue, referred to hereinafter as “copper-containing post-etch residue,” generated during the etching process is difficult to remove, in part because the residue strongly anchors to the sidewalls and top surface. In addition, the copper-containing post-etch residue represents a complex composition of one or all of the following species—Cu, CuO, Cu₂O, Cu(OH)₂, CuF₂, silicon from the dielectric, carbon from the photoresist, fluoride species from the etching gases, etc.

Cleaning of post-etch residues remains a critical process step for any new low-k dielectric material to succeed. As the dielectric constant of the low-k material pushes below 2.4, the chemical and mechanical sensitivity increases (e.g., chemical strength decreases, etc.), thereby requiring shorter process times. Unfortunately, shorter process times generally translates to more aggressive chemistries which can have a detrimental effect on the low-k dielectric material, as well as other stack materials (e.g., copper, etch stop, etc.). Thus, improved cleaning chemistries with very high selectivity are desired.

Copper via diameters are typically 0.18 μm and smaller and as such, there has been much speculation about the ability of aqueous or solvent-based chemistries to effectively clean surfaces having such copper vias thereon. Water has a high surface tension which limits or prevents access to the smaller image, high aspect ratio nodes, and therefore, removing the residues in the crevices or grooves becomes more difficult. In addition, aqueous-based etchant formulations often leave previously dissolved solutes behind in the trenches or vias upon evaporative drying, which reduces device yield. Furthermore, underlying porous low-k dielectric materials do not have sufficient mechanical strength to withstand the capillary stress of high surface tension liquids such as water, resulting in pattern collapse of the structures.

In conventional aqueous etchant formulations, water and/or dissolved oxygen readily oxidizes native copper (Cu) to a dissolvable ionic form, e.g., CuO. Accordingly, avoiding corrosion is a key concern because it impacts device yield and causes premature failure of packaged devices. It is important to design a chemistry that is capable of dissolving oxidized Cu residues while shutting down the thermodynamic drive that draws native copper into solution. This may be accomplished through judicious selection of the medium employed and elimination of any oxidizing agents in the formulation. Corrosion can also be minimized by an additional rinse process step using an organic solvent such as isopropyl alcohol. Many removal materials contain a corrosion inhibitor to reduce corrosion risk and eliminate the additional rinse step. However, many corrosion inhibitors decrease the stripping speed. Thus, there remains a fine balance between removal efficiency and corrosion protection, which must be considered when developing novel copper-containing post-etch residue cleaning formulations.

Dense fluids, including supercritical fluids (SCF), are attractive alternatives for removing copper-containing post-etch residue from the surface of a microelectronic device. SCFs diffuse rapidly, have low viscosity, near zero surface tension, and can penetrate easily into deep trenches and vias. Further, because of their low viscosity, SCFs can rapidly transport dissolved species. However, SCFs are highly non-polar and as such, many species are not adequately solubilized therein.

It would therefore be a significant advance in the art to provide an improved composition that overcomes the deficiencies of the prior art relating to the removal of copper-containing post-etch and/or post-ash residue from patterned microelectronic devices. The improved composition according to the invention effectively removes copper-containing post-etch and/or post-ash residue without damaging the exposed low-k dielectric and metal interconnect structures present on the surface of the microelectronic device.

### SUMMARY OF THE INVENTION

The present invention relates to compositions useful for the removal of residue from the surface of a substrate, preferably the removal of copper-containing post-etch and/or post-ash residue from the surface of microelectronic devices, and methods of using said compositions for removal of same.

In one aspect, the invention relates to a residue removal composition, comprising at least one residue removal composition and at least one diluent, wherein said residue removal composition is suitable for removing post-etch and/or post-ash residue from a microelectronic device having said residue thereon. Preferred diluents include dense fluids, such as supercritical carbon dioxide (SCCO₂), or wet solvents such as water, propylene glycol, propylene glycol methyl ether, propylene carbonate, and combinations thereof.

In another aspect, the invention relates to a residue removal composition comprising at least one copper corrosion inhibitor and at least one solvent, wherein said composition is further characterized by comprising at least one of the following components (I)-(V):

(I) at least one chelating agent;

(II) at least one low-k passivating agent;

(III) at least one chelating agent, and at least one etchant;

(IV) at least one chelating agent and at least one low-k passivating agent; and

(V) at least one chelating agent, at least etchant and at least one low-k passivating agent,

wherein said residue removal composition is useful for removing post-etch and/or post-ash residue from a microelectronic device having said residue thereon. Preferably, the residue removal composition is combined with at least one diluent. Preferred diluents include dense fluids, such as supercritical carbon dioxide (SCCO₂), or wet solvents such as water, propylene glycol, propylene glycol methyl ether, propylene carbonate, and combinations thereof.

In still another aspect, the invention relates to a kit comprising, in one or more containers, residue removal composition reagents, wherein the residue removal composition comprises at least one copper corrosion inhibitor and at least one solvent, wherein said composition is further characterized by comprising at least one of the following components (I)-(V):

(I) at least one chelating agent;

(II) at least one low-k passivating agent;

(III) at least one chelating agent, and at least one etchant;

(IV) at least one chelating agent and at least one low-k passivating agent; and

(V) at least one chelating agent, at least etchant and at least one low-k passivating agent,

wherein the kit is adapted to form a residue removal composition suitable for removing post-etch and/or post-ash residue from a microelectronic device having said residue thereon.

In a further aspect, the invention relates to a method of removing post-etch and/or post-ash residue from a microelectronic device having said residue thereon, said method comprising contacting the microelectronic device with a residue removal composition for sufficient time and under sufficient contacting conditions to at least partially remove said residue from the microelectronic device, wherein the residue removal composition comprises at least one copper corrosion inhibitor and at least one solvent, and wherein said composition is further characterized by comprising at least one of the following components (I)-(V):

(I) at least one chelating agent;

(II) at least one low-k passivating agent;

(III) at least one chelating agent, and at least one etchant;

(IV) at least one chelating agent and at least one low-k passivating agent; and

(V) at least one chelating agent, at least etchant and at least one low-k passivating agent.

In yet another aspect, the present invention relates to a method of manufacturing a microelectronic device, said method comprising contacting the microelectronic device with a dense fluid residue removal composition for sufficient time to at least partially remove post-etch and/or post-ash residue from the microelectronic device having said residue thereon, wherein the dense fluid residue removal composition includes dense carbon dioxide and a residue removal composition comprising at least one copper corrosion inhibitor and at least one solvent, wherein said composition is further characterized by comprising at least one of the following components (I)-(V):

(I) at least one chelating agent;

(II) at least one low-k passivating agent;

(III) at least one chelating agent, and at least one etchant;

(IV) at least one chelating agent and at least one low-k passivating agent; and

(V) at least one chelating agent, at least etchant and at least one low-k passivating agent.

Another aspect of the invention relates to an article of manufacture comprising a residue removal composition, a microelectronic device, and post-etch and/or post-ash residue material.

Yet another aspect of the invention relates to improved microelectronic devices, and products incorporating same, made using the methods of the invention comprising removing post-etch and/or post-ash residue from a microelectronic device having said residue thereon, using the methods and/or compositions described herein, and optionally, incorporating the microelectronic device into a product. Yet another aspect of the invention relates to methods of fabricating a microelectronic device comprising removing post-etch and/or post-ash residue from a microelectronic device substrate having said residue thereon using the above-identified compositions.

Other aspects, features and embodiments of the invention will be more fully apparent from the ensuing disclosure and appended claims.

### DETAILED DESCRIPTION OF THE INVENTION, AND PREFERRED EMBODIMENTS THEREOF

One aspect of the present invention is based on the discovery of compositions that are highly efficacious for the removal of copper-containing post-etch and/or post-ash residue from the surface of patterned microelectronic devices, while maintaining the integrity of the exposed low-k dielectric layers and metal interconnect structures.

For ease of reference, “microelectronic device” corresponds to semiconductor substrates, flat panel displays, and microelectromechanical systems (MEMS), manufactured for use in microelectronic, integrated circuit, or computer chip applications. It is to be understood that the term “microelectronic device” is not meant to be limiting in any way and includes any substrate that will eventually become a microelectronic device or microelectronic assembly.

“Dense fluid,” as used herein, corresponds to a supercritical fluid or a subcritical fluid. The term “supercritical fluid” denotes a material which is under conditions of not lower than a critical temperature, T_{c}, and not less than a critical pressure, P_{c}, in a pressure-temperature diagram of an intended compound. The preferred supercritical fluid employed in the present invention is CO₂, which may be used alone or in an admixture with another additive such as Ar, NH₃, N₂, CH₄, C₂H₄, CHF₃, C₂H₆, n-C₃H₈, H₂O, N₂O and the like. The term “subcritical fluid” describes a solvent in the subcritical state, i.e., below the critical temperature and/or below the critical pressure associated with that particular solvent. Preferably, the subcritical fluid is a high pressure liquid of varying density. Specific reference to SCF-based compositions, specifically supercritical CO₂ (SCCO₂), hereinafter in the broad description of the invention is meant to provide an illustrative example of the present invention and is not meant to limit same in any way.

As defined herein, “low-k dielectric material” corresponds to any material used as a dielectric material in a layered microelectronic device, wherein the material has a dielectric constant less than about 3.5. Preferably, the low-k dielectric materials include low-polarity materials such as silicon-containing organic polymers, silicon-containing hybrid organic/inorganic materials, organosilicate glass (OSG), TEOS, fluorinated silicate glass (FSG), silicon dioxide, and carbon-doped oxide (CDO) glass. It is to be appreciated that the low-k dielectric materials may have varying densities and varying porosities.

“Post-etch residue” and “post-plasma etch residue,” as used herein, corresponds to material remaining following gas-phase plasma etching processes, e.g., BEOL dual-damascene processing. The post-etch residue may be organic, organometallic, organosilicic, or inorganic in nature, for example, silicon-containing material, metal-containing residue material (e.g., copper-containing material), nitrogen-containing material, oxygen-containing material, polymeric residue material, etch gas residue such as chlorine and fluorine, and combinations thereof.

As defined herein, the term “polymeric sidewall residue” corresponds to the residue that remains on the sidewalls of the patterned device subsequent to post-plasma etching processes. The residue is substantially polymeric in nature however, it should be appreciated that inorganic species, e.g., silicon, copper-containing species and/or other metal-containing species, may be present in the residue as well.

“Post-ash residue,” as used herein, corresponds to material remaining following oxidative or reductive plasma ashing to remove hardened photoresist and/or BARC materials. The post-ash residue may be organic, organometallic, organosilicic, or inorganic in nature. For example, the post-ash residue may include metal-containing residue material such as copper-containing residues.

As used herein, “about” is intended to correspond to ±5% of the stated value.

As used herein, “suitability” for removing post-etch and/or post-ash residue from a microelectronic device having said residue thereon corresponds to at least partial removal of said residue from the microelectronic device. Preferably, at least 90% of the residue is removed from the microelectronic device using the compositions of the invention, more preferably at least 95% of the residue is removed, most preferably at least 99% of the residue is removed. It should be appreciated by one skilled in the art that the post-etch and/or post-ash residue may include copper-containing species, or it may not.

As used herein, “concentrate” corresponds to a liquid composition that may be used to remove copper-containing post-etch and/or post-ash residue, either in said concentrated form, i.e., neat, or as a diluted composition, e.g., diluted with a liquid solvent or a dense fluid.

Importantly, the compositions of the present invention must possess good metal compatibility, e.g., a low etch rate on the metal interconnect structures. Preferably, of the etch rate of the metal interconnect structures is less than about 10 Å min⁻¹ using the dense fluid compositions of the present invention, more preferably less than 5 Å min⁻¹, even more preferably less than 3 Å min⁻¹, and most preferably less than 1 Å min⁻¹. Metals of interest include, but are not limited to, copper, tungsten, cobalt, aluminum, tantalum, titanium and ruthenium and silicides and nitrides thereof.

It should be appreciated that the compositions of the invention may be used to remove post-etch residue from a microelectronic device without substantially compromising etch stop layers, low-k dielectric layers and/or metal interconnect layers. In addition, the compositions of the invention may be used to remove post-ash residue from a microelectronic device without compromising the underlying layers, as readily determined by one skilled in the art. “Underlying layers” may consist of hardmask, interlevel dielectric (ILD), metal interconnect structures, and etch stop layers.

Because of its readily manufactured character and its lack of toxicity and negligible environmental effects, SCCO₂ is the preferred phase in the broad practice of the present invention. SCCO₂ is an attractive reagent for removal of microelectronic device process contaminants, since SCCO₂ has the characteristics of both a liquid and a gas. Like a gas, it diffuses rapidly, has low viscosity, near-zero surface tension, and penetrates easily into deep trenches and vias. Like a liquid, it has bulk flow capability as a “wash” medium. SCCO₂ has a density comparable to organic solvents and also has the advantage of being recyclable, thus minimizing waste storage and disposal requirements.

Because of the ionic nature of copper-containing post-etch residue, e.g., CuO, SCCO₂ is not an attractive reagent for the removal of said residue from the microelectronic device surface. Accordingly, to improve the solubility of the copper-containing post-etch and/or post-ash residue in the supercritical fluid, the appropriate chemistries are preferably included therein.

The present invention overcomes the disadvantages associated with the non-polarity of SCCO₂ by the appropriate formulation of residue removal compositions including SCCO₂ and other additives as hereinafter more fully described, and the accompanying discovery that removing copper-containing post-etch and/or post-ash residue from patterned microelectronic devices with a residue removal medium is highly effective and does not damage low-k dielectric or metallic interconnect materials.

Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

In one aspect, the invention relates to a residue removal concentrate for combination with a diluent to form a residue removal composition useful in removing post-etch and/or post-ash residue from a semiconductor device. The concentrate of the present invention includes at least one metal corrosion inhibitor and at least one metal chelating agent. Yet another embodiment of the present invention includes at least one copper corrosion inhibitor and at least one chelating agent. In another embodiment, the concentrate of the present invention includes at least one copper corrosion inhibitor, at least one chelating agent, and at least one solvent. In yet another embodiment, the concentrate of the invention includes at least one copper corrosion inhibitor, at least one chelating agent, at least one solvent, and at least one etchant. In still another embodiment, the concentrate of the invention includes at least one copper corrosion inhibitor, at least one chelating agent, at least one solvent, and at least one low-k passivating agent. In another embodiment, the concentrate of the invention includes at least one copper corrosion inhibitor, at least one chelating agent, at least one solvent, at least one etchant and at least one low-k passivating agent. In each embodiment, at least one surfactant may be included.

In yet another aspect, the concentrate includes at least one copper corrosion inhibitor and at least one low-k passivating agent. In another embodiment, the concentrate includes at least one copper corrosion inhibitor, at least one low-k passivating agent, and at least one solvent. In each embodiment, at least one surfactant may be included.

In still another aspect, the concentrate includes at least one corrosion inhibitor, at least one etchant and at least one solvent. In yet another aspect, the concentrate includes at least one chelating agent, at least one etchant and at least one solvent.

The concentrate according to one embodiment comprises at least one copper corrosion inhibitor and at least one chelating agent. In another embodiment, the concentrate comprises at least one copper corrosion inhibitor, at least one chelating agent, and at least one solvent, present in the following ranges, based on the total weight of the composition:

| | preferably | more preferably | most preferably |
|---|---|---|---|
| component of | (wt. %) | (wt. %) | (wt. %) |
| Copper | about 0.01% | about 0.1% | about 1% |
| corrosion | to about 20.0% | to about 15.0% | to about 10.0% |
| inhibitor(s) | | | |
| Chelating | about 0.01% | about 0.1% | about 1% |
| agent(s) | to about 30.0% | to about 20.0% | to about 10.0% |
| solvent(s) | about 50.0 | about 65.0 | about 80.0 |
| | to about 99.98% | to about 99.8% | to about 98% |

Optionally, this embodiment may further include at least one surfactant in a range from about 0.01 wt. % to about 10.0 wt. %, based on the total weight of the composition. Notably, the residue removal concentrate may comprise, consist of, or consist essentially of at least one copper corrosion inhibitor, at least one chelating agent, and at least one solvent. When surfactant is present, the residue removal concentrate may comprise, consist of, or consist essentially of at least one copper corrosion inhibitor, at least one chelating agent, at least one solvent, and at least one surfactant.

In another embodiment, the concentrate comprises at least one copper corrosion inhibitor, at least one chelating agent, at least one solvent, and at least one etchant, present in the following ranges, based on the total weight of the composition:

| | preferably | more preferably | most preferably |
|---|---|---|---|
| component of | (wt. %) | (wt. %) | (wt. %) |
| Copper | about 0.01% | about 0.1% | about 1% |
| corrosion | to about 20.0% | to about 15.0% | to about 10.0% |
| inhibitor(s) | | | |
| Chelating | about 0.01% | about 0.1% | about 1% |
| agent(s) | to about 30.0% | to about 20.0% | to about 10.0% |
| solvent(s) | about 35.0 | about 55.0 | about 75.0 |
| | to about 99.97% | to about 99.7% | to about 97.5% |
| etchant(s) | about 0.01% | about 0.1% | about 0.5% |
| | to about 15.0% | to about 10.0 | to about 5.0% |

Optionally, this embodiment may further include at least one surfactant in a range from about 0.01 wt. % to about 10.0 wt. %, based on the total weight of the composition. Notably, the residue removal concentrate may comprise, consist of, or consist essentially of at least one copper corrosion inhibitor, at least one chelating agent, at least one solvent, and at least one etchant. When surfactant is present, the residue removal concentrate may comprise, consist of, or consist essentially of at least one copper corrosion inhibitor, at least one chelating agent, at least one solvent, at least one etchant, and at least one surfactant.

In yet another embodiment, the concentrate comprises at least one copper corrosion inhibitor, at least one chelating agent, at least one solvent, and at least one low-k passivating agent, present in the following ranges, based on the total weight of the composition:

| | preferably | more preferably | most preferably |
|---|---|---|---|
| component of | (wt. %) | (wt. %) | (wt. %) |
| Copper | about 0.01% | about 0.1% | about 1% |
| corrosion | to about 20.0% | to about 15.0% | to about 10.0% |
| inhibitor(s) | | | |
| Chelating | about 0.01% | about 0.1% | about 1% |
| agent(s) | to about 30.0% | to about 20.0% | to about 10.0% |
| solvent(s) | about 35.0 | about 55.0 | about 75.0 |
| | to about 99.97% | to about 99.7% | to about 97.5% |
| low-k | about 0.01% | about 0.1% | about 0.5% |
| passivating | to about 15.0% | to about 10.0 | to about 5.0% |
| agent(s) | | | |

Optionally, this embodiment may further include at least one surfactant in a range from about 0.01 wt. % to about 10.0 wt. %, based on the total weight of the composition. Notably, the residue removal concentrate may comprise, consist of, or consist essentially of at least one copper corrosion inhibitor, at least one chelating agent, at least one solvent, and at least one low-k passivating agent. When surfactant is present, the residue removal concentrate may comprise, consist of, or consist essentially of at least one copper corrosion inhibitor, at least one chelating agent, at least one solvent, at least one low-k passivating agent, and at least one surfactant.

In still another embodiment, the concentrate comprises at least one copper corrosion inhibitor, at least one chelating agent, at least one solvent, at least one etchant and at least one low-k passivating agent, present in the following ranges, based on the total weight of the composition:

| | preferably | more preferably | most preferably |
|---|---|---|---|
| component of | (wt. %) | (wt. %) | (wt. %) |
| Copper | about 0.01% | about 0.1% | about 1% |
| corrosion | to about 20.0% | to about 15.0% | to about 10.0% |
| inhibitor(s) | | | |
| chelating | about 0.01% | about 0.1% | about 1% |
| agent(s) | to about 30.0% | to about 20.0% | to about 10.0% |
| solvent(s) | about 20.0 | about 45.0 | about 70.0 |
| | to about 99.96% | to about 99.6% | to about 97% |
| etchant(s) | about 0.01% | about 0.1% | about 0.5% |
| | to about 15.0% | to about 10.0 | to about 5.0% |
| low-k | about 0.01% | about 0.1% | about 0.5% |
| passivating | to about 15.0% | to about 10.0 | to about 5.0% |
| agent(s) | | | |

Optionally, this embodiment may further include at least one surfactant in a range from about 0.01 wt. % to about 10.0 wt. %, based on the total weight of the composition. Notably, the residue removal concentrate may comprise, consist of, or consist essentially of at least one copper corrosion inhibitor, at least one chelating agent, at least one solvent, at least one etchant, and at least one low-k passivating agent. When surfactant is present, the residue removal concentrate may comprise, consist of, or consist essentially of at least one copper corrosion inhibitor, at least one chelating agent, at least one solvent, at least one etchant, at least one low-k passivating agent, and at least one surfactant.

In another embodiment, the concentrate comprises at least one copper corrosion inhibitor at least one low-k passivating agent, and at least one solvent, present in the following ranges, based on the total weight of the composition:

| | preferably | more preferably | most preferably |
|---|---|---|---|
| component of | (wt. %) | (wt. %) | (wt. %) |
| Copper | about 0.01% | about 0.1% | about 1% |
| corrosion | to about 20.0% | to about 15.0% | to about 10.0% |
| inhibitor(s) | | | |
| solvent(s) | about 65.0 | about 75.0 | about 85.0 |
| | to about 99.98% | to about 99.8% | to about 98.5% |
| low-k | about 0.01% | about 0.1% | about 0.5% |
| passivating | to about 15.0% | to about 10.0 | to about 5.0% |
| agent(s) | | | |

Optionally, this embodiment may further include at least one surfactant in a range from about 0.01 wt. % to about 10.0 wt. %, based on the total weight of the composition. Notably, the residue removal concentrate may comprise, consist of, or consist essentially of at least one copper corrosion inhibitor, at least one low-k passivating agent, and at least one solvent. When surfactant is present, the residue removal concentrate may comprise, consist of, or consist essentially of at least one copper corrosion inhibitor, at least one low-k passivating agent, at least one solvent, and at least one surfactant.

Importantly, the residue removal concentrates of the invention are devoid of abrasive material typical of a CMP process and oxidizing agents.

The residue removal compositions of the invention include at least one diluent, preferably at least one dense fluid such as supercritical carbon dioxide (SCCO₂) or a liquid solvent such as water, propylene glycol, propylene glycol methyl ether, propylene carbonate, and combinations thereof, and any one of the aforementioned residue removal concentrates. When the diluent is a dense fluid, e.g., SCCO₂, the dense fluid residue removal composition includes about 0.01 wt. % to about 15.0 wt. % concentrate and about 85.0 to about 99.99 wt. % dense fluid, based on the total weight of the composition. More preferably, the dense fluid residue removal composition includes about 1 wt. % to about 10.0 wt. % concentrate and about 90.0 to about 99 wt. % dense fluid, based on the total weight of the composition. In general, the specific proportions and amounts of dense fluid and residue removal concentrate in relation to each other may be suitably varied to provide the desired removal action of the dense fluid residue removal composition for the post-etch and/or post-ash residue and/or processing equipment, as readily determinable within the skill of the art without undue effort. When the diluent is a liquid, the liquid residue removal composition includes about 0.01 wt. % to about 90.0 wt. % concentrate and about 10.0 to about 99.99 wt. % diluent, based on the total weight of the composition. More preferably, the liquid residue removal composition includes about 1 wt. % to about 50.0 wt. % concentrate and about 50.0 to about 99 wt. % diluent, based on the total weight of the composition. In general, the specific proportions and amounts of liquid diluent and residue removal concentrate in relation to each other may be suitably varied to provide the desired removal action of the liquid residue removal composition for the post-etch and/or post-ash residue and/or processing equipment, as readily determinable within the skill of the art without undue effort. In either case, preferably the post-etch and/or post-ash residue comprises copper-containing species.

The inclusion of the copper corrosion inhibitor serves to eliminate over-etching of copper metal. Suitable copper corrosion inhibitors include, but are not limited to, azoles such as benzotriazole (BTA), 1,2,4-triazole (TAZ), 5-aminotetrazole (ATA), 1-hydroxybenzotriazole, 5-amino-1,3,4-thiadiazol-2-thiol, 3-amino-1H-1,2,4-triazole, 3,5-diamino-1,2,4-triazole, tolyltriazole, 5-phenyl-benzotriazole, 5-nitro-benzotriazole, 3-amino-5-mercapto-1,2,4-triazole, 1-amino-1,2,4-triazole, 2-(5-amino-pentyl)-benzotriazole, 1-amino-1,2,3-triazole, 1-amino-5-methyl-1,2,3-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, 1H-tetrazole-5-acetic acid, 2-mercaptobenzothiazole (2-MBT), 1-phenyl-2-tetrazoline-5-thione, 2-mercaptobenzimidazole (2-MBI), 4-methyl-2-phenylimidazole, 2-mercaptothiazoline, 2,4-diamino-6-methyl-1,3,5-triazine, thiazole, imidazole, benzimidazole, triazine, methyltetrazole, 1,3-dimethyl-2-imidazolidinone, 1,5-pentamethylenetetrazole, 1-phenyl-5-mercaptotetrazole, diaminomethyltriazine, imidazoline thione, 4-methyl-4H-1,2,4-triazole-3-thiol, 5-amino-1,3,4-thiadiazole-2-thiol, benzothiazole, tritolyl phosphate, indiazole, DNA bases (e.g., adenine, cytosine, guanine, thymine), phosphate inhibitors, amines, pyrazoles, propanethiol, silanes, secondary amines, benzohydroxamic acids, heterocyclic nitrogen inhibitors, citric acid, ascorbic acid, thiourea, 1,1,3,3-tetramethylurea, urea, urea derivatives, potassium ethylxanthate, glycine, and mixtures thereof. Dicarboxylic acids such as oxalic acid, malonic acid, succinic acid, nitrilotriacetic acid, iminodiacetic acid, and combinations thereof are also useful copper passivator species. It is generally accepted that azoles chemisorb onto the copper surface and form an insoluble cuprous surface complex. Preferably, the copper corrosion inhibitor includes an azole compound, more preferably ATA, 2-MBT, or 2-MBI.

The inclusion of the chelating agent serves to chelate the oxidized metal whereby the chelated copper-containing post-etch residue is preferably soluble in the carbon dioxide solvent. Suitable chelating agents include, but are not limited to: fluorinated β-diketone chelating agents such as 1,1,1,5,5,5-hexafluoro-2,4-pentanedione (hfacH), 1,1,1-trifluoro-2,4-pentanedione (tfac), and acetylacetonate (acac); pyrazolates; amidinates; guanidinates; ketoimines; dienes; polyamines; ethylenediaminetetraacetic acid (EDTA); 1,2-cyclohexanediamine-N,N,N′,N′-tetraacetic acid (CDTA); etidronic acid; methane sulfonic acid; alkylamines; arylamines; glycolamines; alkanolamines; triazoles; thiazoles; tetrazoles; imidazoles; and amine-N-oxides including, but not limited to, pyridine, 2-ethylpyridine, 2-methoxypyridine and derivatives thereof such as 3-methoxypyridine, 2-picoline, pyridine derivatives, dimethylpyridine, piperidine, piperazine, triethylamine, triethanolamine, ethylamine, methylamine, isobutylamine, tert-butylamine, tributylamine, dipropylamine, dimethylamine, diglycol amine, monoethanolamine, pyrrole, isoxazole, 1,2,4-triazole, bipyridine, pyrimidine, pyrazine, pyridazine, quinoline, isoquinoline, indole, imidazole, N-methylmorpholine-N-oxide (NMMO), trimethylamine-N-oxide, triethylamine-N-oxide, pyridine-N-oxide, N-ethylmorpholine-N-oxide, N-methylpyrrolidine-N-oxide, N-ethylpyrrolidine-N-oxide, 1-methylimidazole, diisopropylamine, diisobutylamine, aniline, aniline derivatives, and combinations of any of the above. Fluorinated β-diketone chelating agents may perform substantially better than non-fluorinated β-diketone chelating agents in compositions employing a carbon dioxide-based diluent. Unlike non-fluorinated β-diketone chelating agents, which may need to be combined with a base to form a deprotonated compound capable of chelation, fluorinated β-diketone chelating agents of the present invention can be used in the absence of a base. Additionally, in contrast to non-fluorinated β-diketone chelating agents, which form less soluble metal chelates (i.e. metal (β-diketonate) complexes or ions) in carbon dioxide, fluorinated β-diketone chelating agents form more soluble metal complexes or ions in carbon dioxide based-diluents.

The inclusion of the solvent serves to increase the solubility of the composition for the chelated copper-containing post-etch residue. Solvent species useful in the removal compositions of the invention may be of any suitable type, including alcohols, amides, ketones, esters, etc. Illustrative species include, but are not limited to, methanol, ethanol, isopropanol, 1-butanol, 3-methyl-1-butanol, and higher alcohols (including diols, triols, etc.), ethers, N-alkylpyrrolidones or N-arylpyrrolidones, such as N-methyl-, N-octyl-, or N-phenyl-pyrrolidones, sulfolane, catechol, ethyl lactate, ethyl acetate, C₁-C₁₀ alkanes (straight, branched or cyclic methane, ethane, propane, butane, pentane, hexane, heptane, octane, nonane, decane), alkenes (straight, branched or cyclic methene, ethene, propene, butene, pentene, hexene, heptene, octene, nonene, decene), amphiphilic species (i.e., diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether), tetrahydrofuran, toluene, acetone, dimethyl formamide, dimethylsulfoxide (DMSO), pyridine, 2,2,3,3,4,4,5,5-octafluoro-1-pentanol, 1H,1H,9H-perfluoro-1-nonanol, perfluoroheptanoic acid, 1H,1H,7H-dodecafluoro-1-heptanol, perfluoropentanoic acid, 1H,1H,8H,8H-dodecafluoro-1,8-octanediol, 2,2,3,3,4,4,5,5-octafluoro-1,6-hexanediol, 5H-perfluoropentanoic acid, n-butyl heptafluorobutyrate, acetonitrile, glycols, water, acetic acid, trifluoroacetic acid, butyl carbitol, methyl carbitol, monoethanolamine, butyrol lactone, diglycol amine, γ-butyrolactone, butylene carbonate, ethylene carbonate, and propylene carbonate, and mixtures thereof. Methanol is especially preferred.

The residue removal compositions of the invention may further include at least one etchant source. Etchants, for example fluorides, may be added to increase the ability to remove residue from the surface of the microelectronic device. Suitable etchants include sources of fluoride or hydrogen fluoride including, but not limited to, hydrogen fluoride (HF); ammonium fluoride (NH₄F); tetraalkylammonium fluoride (NR₄F); alkyl hydrogen fluoride (NRH₃F); ammonium hydrogen bifluoride (NH₅F₂); dialkylammonium hydrogen fluoride (NR₂H₂F); trialkylammonium hydrogen fluoride (NR₃HF); trialkylammonium trihydrogen fluoride (NR₃:3HF); amine hydrogen fluoride complexes; where the amine includes straight-chained or branched C₁-C₂₀ alkylamines, substituted or unsubstituted C₆-C₁₀ arylamines, glycolamines, alkanolamines, and amine-N-oxides including, but not limited to: pyridine; 2-ethylpyridine; 2-methoxypyridine and derivatives thereof such as 3-methoxypyridine; 2-picoline; pyridine derivatives; dimethylpyridine; piperidine; piperazine; triethylamine; triethanolamine; ethylamine, methylamine, isobutylamine, tert-butylamine, tributylamine, dipropylamine, dimethylamine, diglycol amine; monoethanolamine; pyrrole; isoxazole; 1,2,4-triazole; bipyridine; pyrimidine; pyrazine; pyridazine; quinoline; isoquinoline; indole; imidazole; N-methylmorpholine-N-oxide (NMMO); trimethylamine-N-oxide; triethylamine-N-oxide; pyridine-N-oxide; N-ethylmorpholine-N-oxide; N-methylpyrrolidine-N-oxide; N-ethylpyrrolidine-N-oxide; 1-methylimidazole, diisopropylamine, diisobutylamine, aniline, aniline derivatives, and combinations thereof; and xenon difluoride (XeF₂). The R group may be the same as or different from one another and may include any straight-chained or branched C₁-C₁₀ alkyl (e.g., methyl, ethyl, propyl, butyl, pentyl, hexyl, heptyl, octyl, nonyl, decyl) or substituted or unsubstituted C₆-C₁₀ aryl substituent (e.g., benzyl). An amine hydrogen fluoride complex is the preferred source due to its mild fluorination properties and better solubility in dense CO₂.

The residue removal compositions of the invention may further include at least one low-k passivating agent to reduce the chemical attack of the low-k layers and to protect the wafer from additional oxidation. Boric acid is a presently preferred low-k passivating agent, although other hydroxyl additives may also be advantageously employed for such purpose, e.g., 3-hydroxy-2-naphthoic acid, malonic acid, and iminodiacetic acid. Amphiphilic molecules, such as butyl carbitol, may also be employed for such purpose. Preferably, less than 2 wt. % of the underlying low-k material is etched/removed using the residue removal compositions of the present invention, more preferably less than 1 wt. %, most preferably less than 0.5 wt. %, based on the total weight of the underlying low-k material.

The residue removal compositions of the invention may further include a surfactant to assist in residue removal by surrounding the ionic residue with its polar head group. Illustrative surfactants include, but are not limited to, amphoteric salts, cationic surfactants, anionic surfactants, fluoroalkyl surfactants, SURFONYL® 104, TRITON™ CF-21, ZONYL® UR, ZONYL®FSO-100, ZONYL® FSN-100, 3M Fluorad fluorosurfactants (i.e., FC-4430 and FC-4432), dioctylsulfosuccinate salt, 2,3-dimercapto-1-propanesulfonic acid salt, dodecylbenzenesulfonic acid, polyethylene glycols, polypropylene glycols, polyethylene or polypropylene glycol ethers, carboxylic acid salts, R₁ benzene sulfonic acids or salts thereof (where the R₁ is a straight-chained or branched C₈ to C₁₈ alkyl group), amphiphilic fluoropolymers, polyethylene glycols, polypropylene glycols, polyethylene or polypropylene glycol ethers, carboxylic acid salts, dodecylbenzenesulfonic acid, polyacrylate polymers, dinonylphenyl polyoxyethylene, silicone or modified silicone polymers, acetylenic diols or modified acetylenic diols, alkylammonium or modified alkylammonium salts, as well as combinations comprising at least one of the foregoing surfactants, sodium dodecyl sulfate, zwitterionic surfactants, aerosol-OT (AOT) and fluorinated analogues thereof, alkyl ammonium, perfluoropolyether surfactants, 2-sulfosuccinate salts, phosphate-based surfactants, sulfur-based surfactants, and acetoacetate-based polymers.

In various preferred embodiments, the residue removal concentrate may be formulated in the following Formulations A-P:

Formulation A: hfacH, methanol, 2-MBT
Formulation B: hfacH, butanol, 2-MBT
Formulation C: hfacH, methanol, 2-MBT, HF solution (49%)
Formulation D: CDTA, water, butanol, 2-MBI, HF solution (49%)
Formulation E: CDTA, water, butanol, ATA, HF solution (49%)
Formulation F: methanol, 1-methylimidazole, 1,1,3,3-tetramethylurea
Formulation G: 2,2,3,3,4,4,5,5-octafluoro-1-pentanol, hfacH, 2-MBT
Formulation H: 2,2,3,3,4,4,5,5-octafluoro-1-pentanol, hfacH, HF solution (49%), 2-MBT
Formulation I: CDTA, water, propylene glycol, 2-MBI, HF solution (49%)
Formulation J: hfacH, 3-methyl-1-butanol, 2-MBT
Formulation K: CDTA, acetylacetonate, water, propylene carbonate, propylene glycol, 2-MBI
Formulation L: CDTA, acetylacetonate, propylene carbonate, propylene glycol, 2-MBT
Formulation M: CDTA, acetylacetonate, water, propylene carbonate, propylene glycol, ATA
Formulation N: 2-MBI, propylene carbonate, propylene glycol:HF (96%/4% solution)
Formulation O: 2-MBI, propylene carbonate, propylene glycol:HF (96%/4% solution), methane sulfonic acid
Formulation P: Etidronic acid (60% in water), propylene carbonate, propylene glycol:HF (96%/4% solution)

In general, the specific proportions and amounts of diluent, e.g., SCCO₂, and the residue removal concentrate in relation to each other may be suitably varied to provide the desired solubilizing action of the residue removal composition for the copper-containing post-etch and/or post-ash residue to be removed from the microelectronic device. Such specific proportions and amounts are readily determinable by simple experiment within the skill of the art without undue effort.

It is to be understood that the phrase “removing post-etch and/or post-ash residue from a microelectronic device” is not meant to be limiting in any way and includes the removal of post-etch and/or post-ash residue from any substrate that will eventually become a microelectronic device.

It is further contemplated that the residue removal composition of the present invention will efficaciously remove non-copper-containing post-etch residue material as well. “Non-copper containing post-etch residue” as used herein corresponds to silicon-containing material (e.g., silicon nitride, silicon oxide, etc.), carbon-based organic material, and etch gas residue including oxygen and fluorine.

In another embodiment, the residue removal composition of the invention includes at least one diluent, one of the aforementioned residue removal concentrates, and a copper-containing residue material selected from the group consisting of post-etch residue, post-ash residue, and combinations thereof.

The residue removal compositions of the invention may optionally be formulated with additional components to further enhance the removal capability of the composition, or to otherwise improve the character of the composition. Accordingly, the composition may be formulated with stabilizers, complexing agents, reducing agents, etc.

The residue removal compositions of the invention are easily formulated by addition of the residue removal concentrate to a diluent, e.g., SCCO₂. The concentrates may be readily formulated as single-package formulations or multi-part formulations that are mixed with diluent at the point of use. The individual parts of the multi-part formulation may be mixed at the tool or in a storage tank upstream of the tool. The concentrations of the single-package formulations or the individual parts of the multi-part formulation may be widely varied in specific multiples, i.e., more dilute or more concentrated, in the broad practice of the invention, and it will be appreciated that the residue removal compositions of the invention can variously and alternatively comprise, consist or consist essentially of any combination of ingredients consistent with the disclosure herein.

Another aspect of the invention relates to a kit including, in one or more containers, one or more components adapted to form the compositions of the invention. Preferably, the kit includes, in one or more containers, the aforementioned residue removal concentrates including copper corrosion inhibitor(s), solvent(s), chelating agent(s), optional etchant(s), optional low-k passivating agent(s), and/or optional surfactant(s), for combining with the diluent at the fab. The containers of the kit should be chemically rated to store and dispense the component(s) contained therein. For example, the containers of the kit may be NOWPak® containers (Advanced Technology Materials, Inc., Danbury, Conn., USA).

In yet another aspect, the invention relates to methods of removing post-etch and/or post-ash residue from a patterned microelectronic device using the residue removal compositions described herein. For example, trench and via structures on the patterned devices may be cleaned without damaging the low-k dielectric materials or the metal interconnect structures present on the microelectronic device. Moreover, patterned photoresist and ARC materials remain undamaged.

The dense fluid residue removal compositions of the present invention overcome the disadvantages of the prior art removal techniques by minimizing the volume of chemical reagents needed, thus reducing the quantity of waste, while simultaneously providing a composition and method having recyclable constituents, e.g., the dense fluids. Furthermore, the residue removal compositions of the invention are compatible with the metal interconnect structures and effectively remove copper-containing post-etch and/or post-ash residue without substantially damaging the low-k dielectric material.

The residue removal concentrates may be mixed with dense fluid using a static or a dynamic mixer, preferably a dynamic mixer. An example of such a dynamic mixer, which will produce a uniform and homogeneous media of the components in the bulk solvent, is disclosed in U.S. Provisional Patent Application No. 60/672,170, filed Apr. 15, 2005 in the name of Michael B. Korzenski et al., which is hereby incorporated by reference in its entirety. The resulting SCCO₂ formulation may include all components in the supercritical state or alternatively, at least one of the components is not in the supercritical state but instead is solvated in the supercritical fluid.

Once formulated, the dense fluid residue removal compositions are applied to the patterned microelectronic device surface for contacting with the residue thereon, at suitable elevated pressures, e.g., in a pressurized contacting chamber to which the dense fluid composition is supplied at suitable volumetric rate and amount to effect the desired contacting operation, for at least partial removal of the residue from the microelectronic device surface. The chamber may be a batch or single wafer chamber, for continuous, pulsed or static cleaning.

The removal efficiency of the dense fluid residue removal composition may be enhanced by use of elevated temperature and/or pressure conditions in the contacting of post-etch and/or post-ash residue to be removed with the dense fluid residue removal composition.

The appropriate dense fluid residue removal composition may be employed to contact a microelectronic device surface having residue thereon at a pressure in a range of from about 1,000 to about 6,000 psi, preferably in a range of from about 2,500 to about 4,500 psi, for sufficient time to effect the desired removal of the particulate matter, e.g., for a contacting time in a range of from about 1 minute to about 120 minutes and a temperature of from about 25° C. to about 75° C., preferably in a range of from about 30° C. to about 70° C., although greater or lesser contacting durations and temperatures may be advantageously employed in the broad practice of the present invention, where warranted.

The removal process may include a static soak, a dynamic contacting mode, or sequential processing steps including dynamic flow of the dense fluid residue removal composition over the microelectronic device surface, followed by a static soak of the device in the dense fluid residue removal composition, with the respective dynamic flow and static soak steps being carried out alternatingly and repetitively, in a cycle of such alternating steps. A “dynamic” contacting mode involves continuous flow of the composition over the device surface, to maximize the mass transfer gradient and effect removal of the residue from the surface. A “static soak” contacting mode involves contacting the device surface with a static volume of the composition, and maintaining contact therewith for a continued (soaking) period of time.

The alternating dynamic flow/static soak steps may be carried out for successive cycles in the aforementioned illustrative embodiment, as including a sequence of 2.5 min-5 min dynamic flow, 2.5 min-5 min static soak, e.g., at about 3,800 psi, and 2.5 min-5 min dynamic flow.

It is to be appreciated by one skilled in the art that the contacting mode can be exclusively dynamic, exclusively static or any combination of dynamic and static steps needed to effectuate at least partial removal of the post-etch and/or post-ash residue from the microelectronic device surface.

Following the contacting of the dense fluid residue removal composition with the microelectronic device, the device thereafter preferably is washed with copious amounts of supercritical fluid (SCF)/co-solvent solution in a first washing step, to remove any residual precipitated chemical additives from the region of the device surface in which removal has been effected, and finally with copious amounts of neat SCF, in a second washing step, to remove any residual co-solvent and/or precipitated chemical additives from the device surface. Preferably, the SCF used for washing is SCCO₂. For example, the first washing step may use a three volume SCCO₂/co-solvent (20%) solution and the second washing step may use a three volume neat SCCO₂ rinse.

The residue removal concentrates may be mixed with a liquid diluent to form a liquid residue removal composition by simple mixing of ingredients, e.g., in a mixing vessel or the cleaning vessel under gentle agitation.

In passivation and removal application, the liquid residue removal composition is applied in any suitable manner to the microelectronic device having post-etch and/or post ash residue material thereon, e.g., by spraying the composition on the surface of the device, by dipping (in a volume of the composition) of the device including the residue material, by contacting the device with another material, e.g., a pad, or fibrous sorbent applicator element, that has said composition absorbed thereon, by contacting the device including the residue material with a circulating composition, or by any other suitable means, manner or technique, by which the liquid residue removal composition is brought into contact with the residue material on the microelectronic device. The removal application may be static or dynamic, as readily determined by one skilled in the art.

In use of the compositions of the invention for removing post-etch and/or post-ash residue material from microelectronic device surfaces having same thereon, the liquid residue removal composition typically is contacted with the device surface for a time of from about 1 to about 60 minutes. Preferably, temperature is in a range of from about 20° C. to about 80° C., preferably about 30° C. to about 80° C., most preferably about 70° C. Such contacting times and temperatures are illustrative, and any other suitable time and temperature conditions may be employed that are efficacious to at least partially remove the residue material from the device surface, within the broad practice of the invention. As defined herein, “at least partial removal” corresponds to at least 90% removal of the residue material, preferably at least 95% removal. Most preferably, at least 99% of said residue material is removed using the compositions of the present invention.

Following the achievement of the desired removal action, the microelectronic device may be thoroughly rinsed with copious amounts of a first rinsing solution, e.g., water, water/isopropanol, propylene carbonate, to remove any residual chemical additives, and optionally a second rinsing solution, e.g., water, isopropanol, to remove the first rinsing solution.

It will be appreciated that specific contacting conditions for the residue removal compositions of the invention are readily determinable within the skill of the art, based on the disclosure herein, and that the specific proportions of ingredients and concentrations of ingredients in the residue removal compositions of the invention may be widely varied while achieving desired removal of the copper-containing post-etch and/or post-ash residue from the microelectronic device surface.

Yet another aspect of the invention relates to the improved microelectronic devices made according to the methods of the invention and to products containing such microelectronic devices, wherein said devices have reduced residue.

A still further aspect of the invention relates to methods of manufacturing an article comprising a microelectronic device, said method comprising contacting the microelectronic device with one of the above-described dense fluid residue removal compositions for sufficient time to at least partially remove post-etch and/or post-ash residue from the microelectronic device having said residue thereon, and incorporating said microelectronic device into said article. Preferably, the residue removal composition includes at least one diluent, e.g., dense fluid or liquid solvent, and one of the aforementioned residue removal concentrates.

The features and advantages of the invention are more fully shown by the illustrative example discussed below.

### Example 1

Blanketed DUO-like material, TEOS, SiN, ULK, OSG, SiCN and Cu films were statically immersed in Formulations N-P for 10 minutes at 40° C. Following processing, the wafers processed with Formulations N and O were rinsed with propylene carbonate, then IPA and then dried. The wafers processed with Formulation P were rinsed with water, then IPA and then dried. Formulation N included 0.25 wt. % 2-MBI, 74.81 wt. % propylene carbonate, and 24.94 wt. % propylene glycol:HF (96%/4% solution); Formulation O included 0.25 wt. % 2-MBI, 74.62 wt. % propylene carbonate, 24.88 wt. % propylene glycol:HF (96%/4% solution), and 0.25 wt. % methane sulfonic acid; and Formulation P includes 0.25 wt. % etidronic acid (60% in water), 74.81 wt. % propylene carbonate, and 24.94 wt. % propylene glycol:HF (96%/4% solution). The etch rates of the films were determined using a Nanospec. The results are summarized in Table 1 hereinbelow.

| | DUO-like | OSG ER/ | ULK ER/ | TEOS ER/ | SiN ER/ | SiCN ER/ | Cu ER/ |
|---|---|---|---|---|---|---|---|
| formulation | ER/Å min⁻¹ | Å min⁻¹ | Å min⁻¹ | Å min⁻¹ | Å min⁻¹ | Å min⁻¹ | Å min⁻¹ |
| N | 25.9 | 0 | 2.5 | 2.9 | 1.2 | 0.8 | 0.7 |
| O | 22.6 | 0 | 2.6 | 3.2 | 1.2 | 1.1 | 3.8 |
| P | 26.6 | 0 | 2.5 | 3.4 | 1.6 | 0.7 | 2.8 |

It can be seen that formulations N-P will not compromise low-k dielectric material, etch stop layers or metal materials, e.g., copper. In addition, the formulations substantially removed post-etch and post-ash residue from a patterned substrate having same thereon.

While the invention has been described herein in reference to specific aspects, features and illustrative embodiments of the invention, it will be appreciated that the utility of the invention is not thus limited, but rather extends to and encompasses numerous other aspects, features and embodiments. Accordingly, the claims hereafter set forth are intended to be correspondingly broadly construed, as including all such aspects, features and embodiments, within their spirit and scope.

1. A residue removal composition comprising at least one copper corrosion inhibitor and at least one solvent, wherein said concentrate is further characterized by comprising at least one of the following components (I)-(II):
(I) at least one chelating agent; or
(II) at least one chelating agent and at least one etchant,
wherein said residue removal concentrate is useful for removing post-etch and/or post-ash residue from a microelectronic device having said residue thereon.

2. (canceled)

3. (canceled)

4. The residue removal composition of claim 1, further comprising at least one surfactant, at least one low-k passivating agent, at least one diluent, or combinations thereof.

5. The residue removal composition of claim 1, wherein the residue comprises copper.

6. (canceled)

7. The residue removal composition as in one of claims 1-5, wherein said solvent comprises at least one solvent selected from the group consisting of alcohols, ethers, amines, amides, ketones, esters, sulfur-containing solvents, alkanes, alkenes, glycols, glycol ethers, alkylene carbonates, and combinations thereof;
wherein the chelating agent comprises a chelant species selected from the group consisting of 1,1,1,5,5,5-hexafluoro-2,4-pentanedione, 1,1,1-trifluoro-2,4-pentanedione, acetylacetonate, ethylenediaminetetraacetic acid (EDTA), 1,2-cyclohexanediamine-N,N,N′,N′-tetraacetic acid (CDTA), and combinations thereof; and
wherein the copper corrosion inhibitor comprises a species selected from the group consisting of 1,2,4-triazole (TAZ), 5-aminotetrazole (ATA), 1-hydroxybenzotriazole, 5-amino-1,3,4-thiadiazol-2-thiol, 3-amino-1H-1,2,4-triazole, 3,5-diamino-1,2,4-triazole, tolyltriazole, 5-phenyl-benzotriazole, 5-nitro-benzotriazole, 3-amino-5-mercapto-1,2,4-triazole, 1-amino-1,2,4-triazole, 2-(5-amino-pentyl)-benzotriazole, 1-amino-1,2,3-triazole, 1-amino-5-methyl-1,2,3-triazole, 3-mercapto-1,2,4-triazole, 3-isopropyl-1,2,4-triazole, 5-phenylthiol-benzotriazole, halo-benzotriazoles, naphthotriazole, 1H-tetrazole-5-acetic acid, 2-mercaptobenzothiazole (2-MBT), 1-phenyl-2-tetrazoline-5-thione, 2-mercaptobenzimidazole (2-MBI), 4-methyl-2-phenylimidazole, 2-mercaptothiazoline, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, imidazoline thione, 4-methyl-4H-1,2,4-triazole-3-thiol, 5-amino-1,3,4-thiadiazole-2-thiol, benzothiazole, tritolyl phosphate, imidazole, benzimidazole, oxalic acid, malonic acid, succinic acid, nitrilotriacetic acid, iminodiacetic acid, indiazole, adenine, cytosine, guanine, thymine, phosphate inhibitors, pyrazoles, propanethiol, benzohydroxamic acids, heterocyclic nitrogen inhibitors, citric acid, ascorbic acid, thiourea, 1,1,3,3-tetramethylurea, urea, urea derivatives, potassium ethylxanthate, glycine, and mixtures thereof.

8.-12. (canceled)

13. The residue removal composition of claim 1, comprising component (II), wherein the etchant comprises a fluoride species selected from the group consisting of: hydrogen fluoride; ammonium fluoride; alkyl hydrogen fluoride; dialkylammonium hydrogen fluoride; trialkylammonium hydrogen fluoride; trialkylammonium trihydrogen fluoride; triethylamine hydrogen fluoride; tetraalkylammonium fluoride; ammonium hydrogen bifluoride; pyridine hydrogen fluoride; amine hydrogen fluoride complexes; xenon difluoride; and mixtures thereof.

14. The residue removal composition of claim 13, wherein the amine comprises a species selected from the group consisting of straight-chained C₁-C₂₀ alkylamines, branched C₁-C₂₀ alkylamines, substituted C₆-C₁₀ arylamines, unsubstituted C₆-C₁₀ arylamines, glycolamines, alkanolamines, and amine-N-oxides.

15. (canceled)

16. The residue removal composition of claim 4, comprising at least one low-k passivating agent, wherein the low-k passivating agent comprises a hydroxyl additive selected from the group consisting of boric acid, 3-hydroxy-2-naphthoic acid, malonic acid, iminodiacetic acid, butyl carbitol, and mixtures thereof.

17. (canceled)

18. The residue removal composition according to claim 5, wherein the residue comprises species selected from the group consisting of Cu, CuO, Cu₂O, Cu(OH)₂, CuF₂, silicon, carbon, fluorine, and combinations thereof.

19. The residue removal composition of claim 1, wherein said composition further comprises residue material, wherein said residue material comprises material selected from the group consisting of post-etch residue material, post-ash residue material, and combinations thereof.

20. (canceled)

21. (canceled)

22. The residue removal composition according to claim 6, comprising at least one diluent, wherein the diluent comprises a supercritical fluid (SCF).

23. (canceled)

24. (canceled)

25. The residue removal composition according to claim 6, comprising at least one diluent, wherein the diluent comprises a solvent selected from the group consisting of water, propylene glycol, propylene glycol methyl ether, propylene carbonate, and combinations thereof.

26. A kit comprising, in one or more containers, residue removal composition reagents, wherein the residue removal composition comprises at least one copper corrosion inhibitor, at least one solvent, optionally at least one surfactant, and optionally at least one low-k passivating agent, wherein said composition is further characterized by comprising at least one of the following components (I)-(II):
(I) at least one chelating agent; or
(II) at least one chelating agent, and at least one etchant,
wherein the kit is adapted to form a residue removal composition suitable for removing copper-containing post-etch and/or post-ash residue from a microelectronic device having said residue thereon.

27. A method of removing post-etch and/or post-ash residue from a microelectronic device having said residue thereon, said method comprising contacting the microelectronic device with a residue removal composition for sufficient time and under sufficient contacting conditions to at least partially remove said residue from the microelectronic device, wherein the residue removal composition comprises at least one copper corrosion inhibitor and at least one solvent, and wherein said composition is further characterized by comprising at least one of the following components (I)-(II):
(I) at least one chelating agent; or
(II) at least one chelating agent, and at least one etchant.

28. The method of claim 27, wherein the residue removal composition further comprises at least one diluent.

29. The method of claim 28, wherein the diluent comprises a supercritical fluid (SCF).

30. (canceled)

31. The method of claim 28, wherein the diluent comprises a solvent selected from the group consisting of water, propylene glycol, propylene glycol methyl ether, propylene carbonate, and combinations thereof.

32. The method of claim 27, wherein the residue removal composition further comprises a component selected from the group consisting of at least one surfactant, at least one low-k passivating agent, and combinations thereof.

33. The method of claim 29, wherein the contacting comprises conditions selected from the group consisting of; pressure in a range of from about 1000 to about 6,000 psi; time in a range of from about 1 minute to about 120 minutes; temperature in a range from about 25° C. to about 75° C.; and combinations thereof.

34. The method of claim 31, wherein said contacting comprises conditions selected from the group consisting of: time of from about 1 minute to about 60 minutes; temperature in a range of from about 30° C. to about 80° C.; and combinations thereof.

35.-37. (canceled)

38. The method of claim 27, wherein the residue removal composition further comprises residue material, wherein said residue material comprises material selected from the group consisting of post-etch residue material, post-ash residue material, and combinations thereof.

39.-45. (canceled)
